(19) United States
(12) Patent Application Publication
(10) Pub. No.: US 2015/0130959 A1
(43) Pub. Date: May 14, 2015

(54) IMAGE PROCESSING DEVICE AND EXPOSURE CONTROL METHOD

(71) Applicant: Himax Imaging Limited, Tainan City (TW)

(72) Inventors: Kun-Yi Kao, Tainan City (TW); Huan-Pin Tseng, Tainan City (TW)

(73) Assignee: Himax Imaging Limited, Tainan City (TW)

(21) Appl. No.: 14/270,606

(22) Filed: May 6, 2014

Related U.S. Application Data
(60) Provisional application No. 61/904,062, filed on Nov. 14, 2013.

(51) Int. Cl. H04N 5/235; H04N 5/232

(52) U.S. Cl. CPC H04N 5/2353; H04N 5/23232
USPC 348/218.1

(57) ABSTRACT

An image processing device is provided. The image processing device includes a sensor array having a plurality of light sensors, configured to receive reflected light of a scene and generate an image array; an exposure controller, configured to receive the image array from the sensor array, and segment the image array into at least one regions; at least two timing controllers, wherein each timing controller is configured to receive pixel data of one of the at least one regions, respectively, and apply an individual exposure setting to the corresponding region; and an image processor, configured to generate an exposed image by organizing the exposed regions from the timing controllers.

### CROSS REFERENCE TO RELATED APPLICATIONS

This application claims the benefit of U.S. Provisional Application No. 61/904,062, filed Nov. 14, 2013, the entirety of which is incorporated by reference herein.

### BACKGROUND OF THE INVENTION

1. Field of the Invention

The present invention relates to image processing, and in particular, to an image processing device and an exposure control method thereof.

2. Description of the Related Art

CMOS active pixel sensors represent a digital solution to obtaining an image of an impinging scene. CMOS technology enables integrating electronics associated with the image sensing onto the chip. This includes, for example, one or more analog-to-digital converters on the chip, as well as timing and control circuitry.

One important feature of a well-defined image is exposure. Some cameras include automatic gain and exposure control. The automatic gain and exposure control determines if the image is underexposed or overexposed, and can adjust some feature of the image acquisition to correct the exposure level. However, conventional cameras may only expose the incoming image with a single exposure setting, and some portion of the incoming image may be overexposed or underexposed, resulting in poor image quality.

### BRIEF SUMMARY OF THE INVENTION

A detailed description is given in the following embodiments with reference to the accompanying drawings.

In an exemplary embodiment, an image processing device is provided. The image processing device includes a sensor array having a plurality of light sensors, configured to receive reflected light of a scene and generate an image array; an exposure controller, configured to receive the image array from the sensor array, and segment the image array into at least one region; at least two timing controllers, wherein each timing controller is configured to receive pixel data from one of the at least one region, and apply an individual exposure setting to the corresponding region; and an image processor, configured to generate an exposed image by organizing the exposed regions from the timing controllers.

In another exemplary embodiment, an exposure control method for use in an image processing device is provided. The image processing device includes a sensor array, and an image processor. The method includes the steps of: receiving reflected light of a scene and generating an image array by the sensor array; segmenting the image array into at least one region; applying an individual exposure setting to the corresponding region; and generating an exposed image by organizing the exposed regions from the timing controllers by the image processor.

### BRIEF DESCRIPTION OF THE DRAWINGS

The present invention can be more fully understood by reading the subsequent detailed description and examples with references made to the accompanying drawings, wherein:

FIG. 1 is a block diagram illustrating an image processing device 100 in accordance with an embodiment of the invention;

FIG. 2 is a diagram illustrating an image including portions of a bright scene and a dark scene;

FIGS. 3A˜3D are diagrams illustrating different image segmentations in accordance with different embodiments of the invention;

FIG. 4 is a flow chart illustrating an exposure control method in accordance with an embodiment of the invention; and

FIG. 5 is a block diagram illustrating an image processing device 100 in accordance with another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

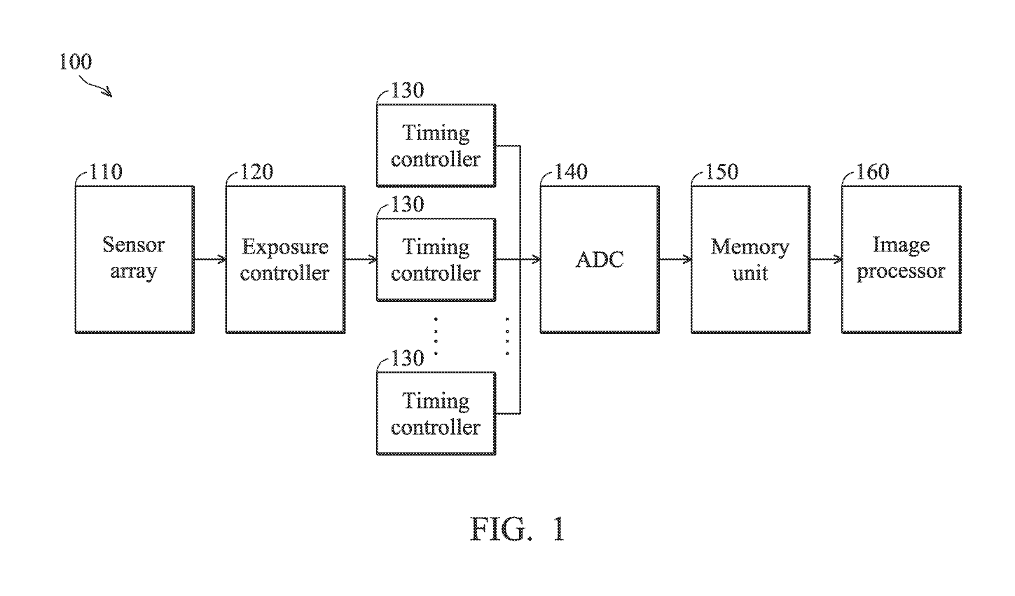

FIG. 1 is a block diagram illustrating an image processing device 100 in accordance with an embodiment of the invention. In an embodiment, the image processing device 100 includes a sensor array 110, an exposure controller 120, at least two timing controllers 130, an analog-to-digital converter (ADC) 140, a memory unit 150, and an image processor 160. In an embodiment, the sensor array 110 includes multiple light sensors such as complementary metal-oxide-semiconductor (CMOS) sensors, charge-coupled device (CCD) sensors, or other sensors known to those skilled in the art, for capturing incoming light of a scene. The exposure controller 120 is configured to split the incoming pixel data from the sensor array into the timing controllers 130 based on image segmentation results (details will be described later). The ADC 140 is configured to convert the analog pixel data into digital pixel data. The memory unit 150, which may be a line buffer or a frame buffer for example, is configured to store the digital pixel data from the timing controllers 130. The image processor 160 is configured to perform subsequent image processing on the digital pixel data, such as a high dynamic range process, a white balance process, a noise reduction process, etc.

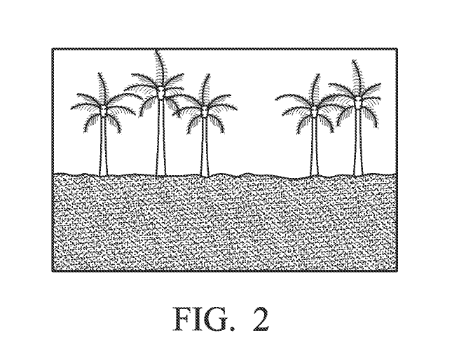

FIG. 2 is a diagram illustrating an image including portions of a bright scene and a dark scene. In an embodiment, the average gray level of all pixels in an image is usually used. However, this may produce some disadvantageous results. For example, consider an image that includes portions of a bright scene and a dark scene, as shown in FIG. 2. If exposure control is performed at the frame level, it may result in a fifty percent correct exposure result and a fifty percent poor exposure result, especially when performing an exposure control process on an image with a high dynamic range. If the correct exposure results for the bright scene and the dark scene are desired, different integration time should be set for scenes having different luminance levels. Specifically, to reach the same exposure level, a longer integration time should be applied to the dark scene. Accordingly, a segmentation-based exposure control method is provided in the invention.

In an embodiment, when only one timing controller 130 is deployed in the image processing device 100, it may indicate that the pixel data of the incoming image array can only be exposed with one exposure setting, resulting in imbalanced exposure results in either bright scenes or dark scenes. In another embodiment, when at least two timing controllers 130 are deployed in the image processing device 100, the exposure controller 120 may analyze the incoming image array and divide the incoming image array into different regions.

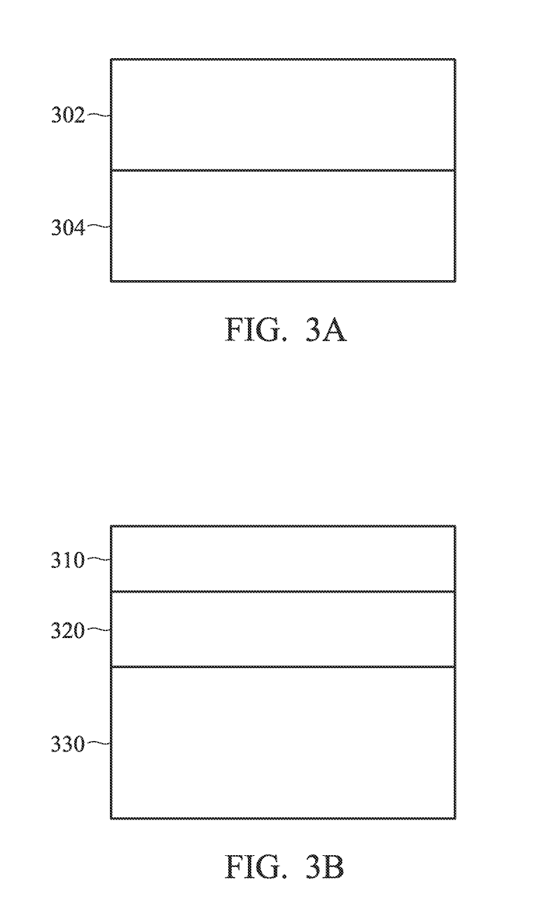

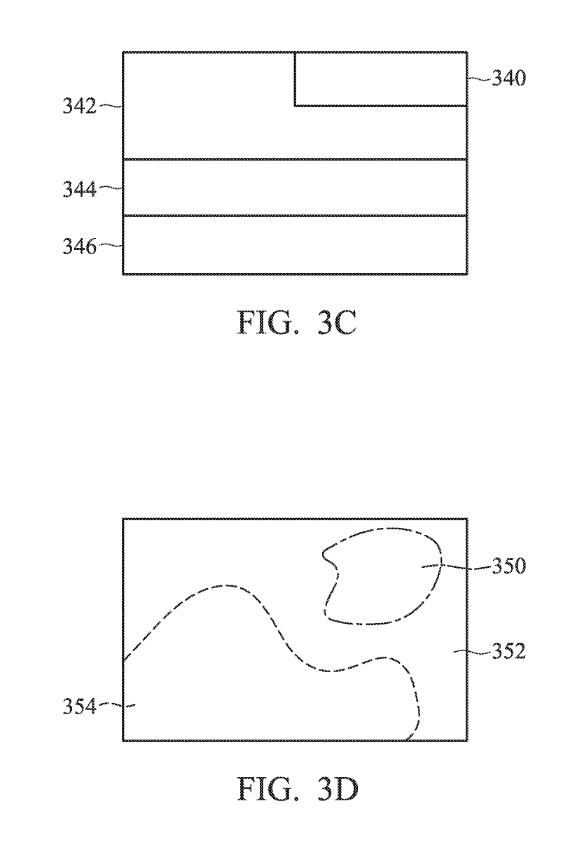

FIGS. 3A˜3D are diagrams illustrating different image segmentations in accordance with different embodiments of the invention. In an embodiment, referring to FIG. 3A, the exposure controller 120 may segment the incoming image array from the sensor array 110 into regions 302, and 304 when the exposure controller 120 determines that there are two regions with distinct image features (e.g. average or distribution of gray levels) which are similar to FIG. 2.

In an embodiment, referring to FIG. 3B, the exposure controller 120 may segment the incoming image array from the sensor array 110 into regions 310, 320 and 330 when the exposure controller 120 determines that there are three portions with distinct image features. For example, the exposure controller 120 may analyze the average value and distribution of gray level of pixels in different regions in the image 300, and then segment the image 300 based on the average and distribution of the gray levels of the pixels in different regions. For one having ordinary skill in the art, it is appreciated that the segmentation algorithms based on gray levels are well-known, and thus the details will be omitted here. When it is determined that there are three major regions 310, 320 and 330 in the image 300, the exposure controller 120 may further transmit image data from each region to its corresponding timing controller 130. For example, the pixel data of the regions 310, 320, and 330 are transmitted to the first, second, third timing controller 130, respectively. It should be noted that the segmentation of the image 300 is rectangle-based or slice-based, and each region may contain complete horizontal lines of the image array.

Referring to FIG. 3C, the exposure controller 120 may segment the image 300 into four regions 340, 342, 344, and 346, and transmit the pixel data of each region to its corresponding timing controller 130. Specifically, the pixel data of regions 340, 342, 344 and 346 are transmitted to the first, second, third, and fourth timing controller 130, respectively. It should be noted that the segmentation of the image 300 in FIG. 3B is different from that in FIG. 3A, and the segmented region may be a rectangle or a trapezoid, and each region may contain a portion of horizontal lines of the image array.

Referring to FIG. 3D, the exposure controller 120 may segment the image into three regions 350, 352, and 354. The exposure controller 120 may transmit the pixel data of the regions 350, 352, and 354 to first/second/third timing controllers 130, respectively. The segmentation of the image 300 in FIG. 3D is different from those in FIGS. 3A˜3C. The segmented regions may be any shape and size depending on the segmentation results, and are not limited to rectangles or trapezoids. Specifically, object segmentation or foreground/background segmentation algorithms known to those skilled in the art can be used to segment objects in the image 300.

In view of the above, each of the timing controllers 130 may receive pixel data of a segmented region, and apply corresponding exposure settings to the segmented region. For example, a longer integration time is applied to a region having pixels with smaller gray levels (i.e. a dark scene), and a shorter integration time is applied to a region having pixels with higher gray levels (a bright scene). In addition, the integration time for each timing controller 130 is also adjustable, and the overall exposure result of the whole image can be balanced without sacrificing the image quality of a certain region.

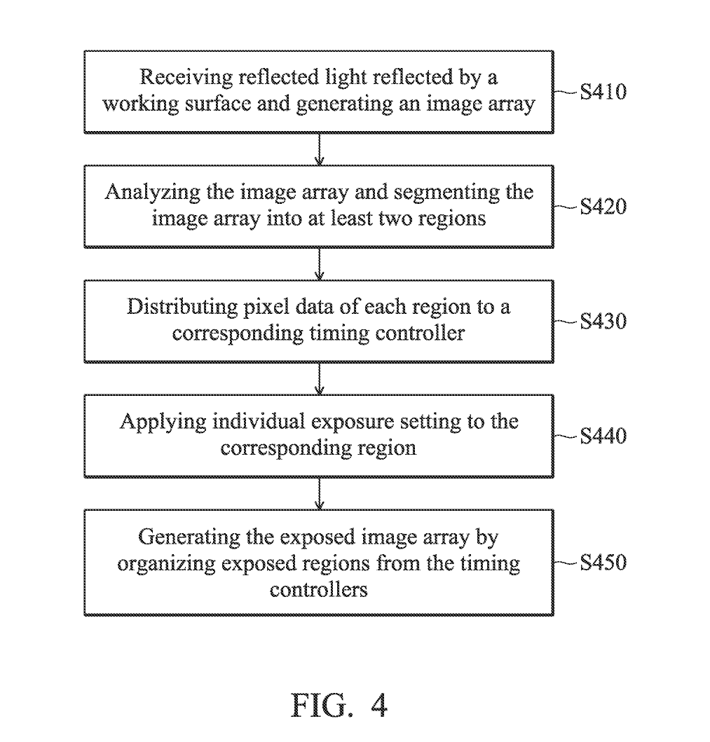

FIG. 4 is a flow chart illustrating an exposure control method in accordance with an embodiment of the invention. In step S410, the sensor array 110 receives reflected light reflected by a scene and generates an image array based on the received light. In step S420, the exposure controller 120 analyzes the image array from the sensor array 110 and segments the image array into at least two regions. In step S430, the exposure controller 120 distributes pixel data from each region to a corresponding timing controller 130. In step S440, each timing controller 130 applies an individual exposure setting to the corresponding region. In step S450, the image processor generates the exposed image array by organizing the exposed regions from the timing controllers 130.

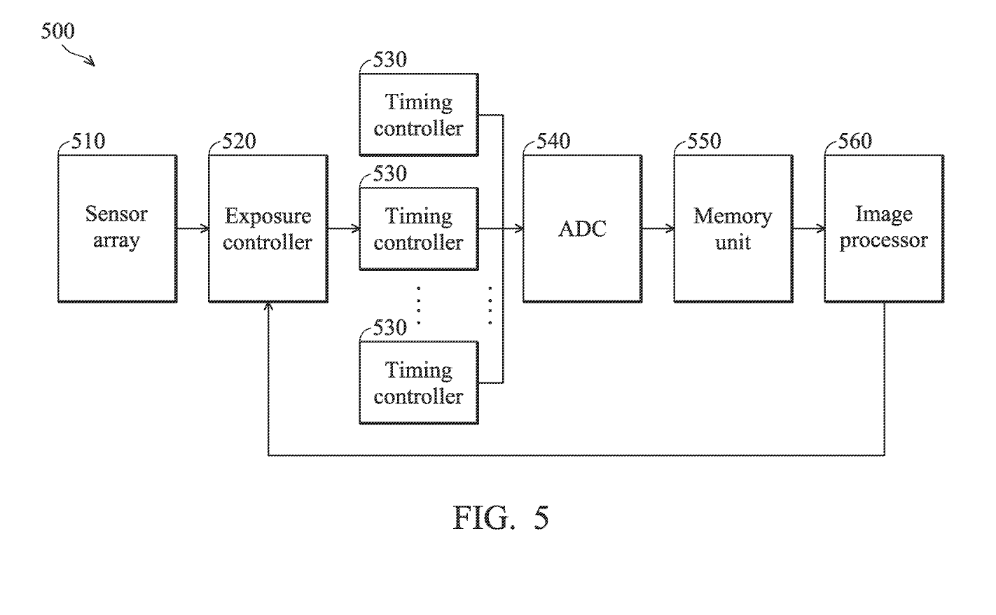

FIG. 5 is a block diagram illustrating an image processing device 500 in accordance with another embodiment of the invention. In another embodiment, the components of the image processing device 500 are the same as those of the image processing device 100. The difference between the image processing devices 100 and 500 is that there is a feedback path from the image processor 560 to the exposure controller 520. Since the image analyzing and image segmentation operations may exhaust hardware resources, it may cause a serious burden to the exposure controller 120. Specifically, the image processor 160 may retrieve the whole exposed image by using only one timing controller 130 (i.e. single exposure setting), and then analyze the retrieved exposed image. It may indicate that the originally exposed image may be in poor image effect. The image processor 160 may further use an object segmentation algorithm to segment the exposed image into multiple regions (or objects), and then transmit the segmentation information back to the exposure controller 120, so that the exposure controller 120 may distribute correct pixel data of each region in the image array to a corresponding timing controller 130 based on the feedback segmentation information from the image processor 160.

In view of the above, an image processing device and an exposure control method capable of applying an individual exposure setting to each segmented region in an image are provided in the invention. With exposure control of each segmented region, the overall exposure result of an image becomes more balanced without sacrificing the image quality of a certain region.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image processing device, comprising
an sensor array comprising a plurality of light sensors, configured to receive reflected light of a scene and generate an image array;
an exposure controller, configured to receive the image array from the sensor array, and segment the image array into at least one region;
at least two timing controllers, wherein each timing controller is configured to receive pixel data of one of the at least one region, respectively, and apply an individual exposure setting to the corresponding region; and
an image processor, configured to generate an exposed image by organizing the exposed regions from the timing controllers.

2. The image processing device as claimed in claim 1, wherein the light sensors are complementary metal-oxide semiconductor (CMOS) sensors or charge-coupled device (CCD) sensors.

3. The image processing device as claimed in claim 1, wherein the exposure controller analyzes the image array to obtain average gray levels of pixels in different regions of the image array, and segment the image array based on the average gray levels.

4. The image processing device as claimed in claim 1, wherein the at least one regions are rectangles and/or trapezoids.

5. The image processing device as claimed in claim 1, wherein the exposure controller further uses an object segmentation algorithm to segment the at least one region, and the segmented region can be any shape and size.

6. The image processing device as claimed in claim 1, further comprising:
an analog-to-digital converter, configured to convert the exposed image array from the timing controllers to a digital image array, and store the digital image array into a memory unit.

7. The image processing device as claimed in claim 6, wherein the memory unit is a line buffer or a frame buffer, and the image processor retrieves the digital image array from the memory unit to generate the exposed image.

8. The image processing device as claimed in claim 1, wherein the individual exposure setting is an integration time of each region, and the integration time used in each timing controller is adjustable.

9. An exposure control method for use in an image processing device, wherein the image processing device comprises a sensor array, and an image processor, the method comprising:
receiving reflected light of a scene and generating an image array by the sensor array;
segment the image array into at least one regions;
applying an individual exposure setting to the corresponding region; and
generating an exposed image by organizing the exposed regions from the timing controllers by the image processor.

10. The exposure control method as claimed in claim 9, wherein the sensor array comprises a plurality of light sensors, and the light sensors complementary metal-oxide semiconductor (CMOS) sensors or charge-coupled device (CCD) sensors.

11. The exposure control method as claimed in claim 9, further comprising:
analyzing the image array to obtain average gray levels of pixels in different regions of the image array; and
segmenting the image array based on the average gray levels.

12. The exposure control method as claimed in claim 9, wherein the at least

13. The exposure control method as claimed in claim 9, further comprising:
using an object segmentation algorithm to segment the at least one region, wherein the segmented region is of any shape and size.

14. The exposure control method as claimed in claim 9, wherein the individual exposure setting is an integration time of each region, and the integration time used in each timing controller is adjustable.
